(19) United States
(12) Patent Application Publication
(10) Pub. No.: US 2005/0193105 A1
(43) Pub. Date: Sep. 1, 2005

(54) Method and system for processing network discovery data

(76) Inventors: Robert Beverley Basham, Aloha, OR (US); David Lynn Merbach, Rochester, MN (US); Sunil Bharadwaj, Portland, OR (US)

Correspondence Address: TIMOTHY N. ELLIS, PATENT ATTORNEY, 8680 VIA MALLORCA, SUITE D, LA JOLLA, CA, 92037, US

(21) Appl. No.: 10/789,124

(22) Filed: Feb. 27, 2004

(51) Int. Cl. G06F 15/173

(52) U.S. Cl. 709/223

(57) ABSTRACT

One aspect of the invention is a method for processing network discovery data. An example of the method includes defining a plurality of network data aggregations. This example also includes assigning a current state value to at least one of the data aggregations. This example further includes, for at least one current state value, determining if the current state value is different than a corresponding prior state value. This example also includes merging data corresponding with at least one data aggregation determined to have a current state value that is different than a corresponding prior state value, with prior data corresponding with at least one data aggregation determined to have a current state value that is not different than a corresponding prior state value.

### BACKGROUND

1. Technical Field

The present invention relates to discovering information concerning a computing network. More particularly, the invention concerns using state values corresponding with data aggregations to process network discovery data.

2. Description of Related Art

Modern computing systems often include a large number of computing devices and storage devices. The computing devices and storage devices may be interconnected via a Storage Area Network (SAN), which generally permits the computing devices to access any of the storage devices that are connected to the SAN.

A SAN provides an environment in which data storage devices are managed within a high speed network that is dedicated to data storage. Access to the SAN may be provided via one or more storage manager servers that handle data storage requests (for example, copy, backup, etc.) from data client nodes (data clients), for example via conventional LAN (Local Area Network) or WAN (Wide Area Network) connections. Storage manager servers are programmed data processing platforms that maintain interfaces to the client-side LAN/WAN and to the storage-side devices that define the data storage network's pool of peripheral storage devices. These storage devices may include any number of interconnected magnetic disk drive arrays, optical disk drive arrays, magnetic or optical tape libraries, etc. Interconnectivity in a SAN may be provided with arbitrated loop arrangements, or more commonly, with switching fabrics. Typical interconnectivity components may include copper or fiber optic cables, hubs, bridges, gateways, switches, directors, and other data communication equipment designed for high speed data transfer between and among all of the interconnected storage manager servers and storage devices that may be coupled to (or that may be considered to be part of) the data storage network.

Management applications, for example SAN management applications, storage resource management applications, and/or storage management applications, are often employed to manage and configure SANs. Management applications may perform key functions such as discovering the components included in a SAN configuration, discovering attributes of the components, and discovering and mapping the physical and logical relationships between the components. As an example, component attributes could include physical and logical storage unit identification information and port information, and could also include file system information and operating system information. Generally, management applications may monitor network storage devices and their logical integration with storage manager servers, and may also monitor network interconnectivity components, and the storage manager servers. Management applications may perform these functions on a continual basis in order to manage the SAN configuration and/or to store and render current snapshots of the SAN configuration.

The management applications may process SAN information that is received from software agents that are located throughout the SAN. An agent is a logical entity that may reside on a network node, such as a storage manager server, a storage device, or a network interconnectivity component. An agent may be programmed to provide information about a portion of a data storage network to a supervising management application. Usually the information is obtained from multiple agents, because a single agent typically will not have complete SAN configuration information.

A network management server typically receives the information from the agents and attempts to create a coherent view of the network. Obtaining information from the agents may be called conducting a discovery poll. The term “discovery poll” refers to the discovery of data storage network information via a management application's agents, and the subsequent processing of that information by the management application. Discovery polls may be scheduled or on-demand, or may be triggered by asynchronous events. Obtaining and combining the information received from agents is generally resource intensive because discovery polls may occur frequently, because a large number of agents may used to obtain complete information about a SAN configuration, because the information obtained from the agents may be large and complex (depending on the size and complexity of the SAN configuration), and because the list of agents may grow and shrink dynamically. Due to the fact that new requests for discovery polls can arise while a previous discovery poll is being processed, discovery processing can become severely backlogged, and undesirable delays in fulfilling processing requests may occur.

A network may include hundreds of network management servers, each of which has a discovery agent. With current methods for performing the discovery process, typically all of the discovery agents available in the network are used to retrieve and process information. This can result in large processing times, because the time required for obtaining and processing the information is proportional to the number of agents, and is also proportional to the size and complexity of the information gathered by the agents. Also, because all agents gather information even if the gathered information overlaps the information gathered by another agent, SAN performance may be adversely impacted due to the bandwidth utilized by the agents. Consequently, known techniques are generally inadequate for producing a current view of a network in a time efficient manner.

### SUMMARY

One aspect of the invention is a method for processing network discovery data. An example of the method includes defining a plurality of network data aggregations. This example also includes assigning a current state value to at least one of the data aggregations. This example further includes, for at least one current state value, determining if the current state value is different than a corresponding prior state value. This example also includes merging data corresponding with at least one data aggregation determined to have a current state value that is different than a corresponding prior state value, with prior data corresponding with at least one data aggregation determined to have a current state value that is not different than a corresponding prior state value.

Other aspects of the invention are described in the sections below, and include, for example, a computing system, and a signal bearing medium tangibly embodying a program of machine-readable instructions executable by a digital processing apparatus to perform operations for processing network discovery data.

Some examples of the invention advantageously permit monitoring network discovery data received from a number of sources, in a time efficient manner. Additionally, some examples of the invention have the capability to quickly determine when there has been no change in a system. Also, some examples of the invention reduce transmissions between agent services and a management client. Further, some examples of the invention permit analysis to be limited to the locality of changes in a network. Further, some examples of the invention are easily scalable to different sized networks. The invention also provides a number of other advantages and benefits, which should be apparent from the following description.

### BRIEF DESCRIPTION OF THE DRAWINGS

FIG. 1 is a block diagram of the hardware components and interconnections of a computing system in accordance with an example of the invention.

FIG. 2 is a block diagram of the hardware components and interconnections of a computing apparatus in accordance with an example of the invention.

FIG. 3 is an example of a signal-bearing medium in accordance an example of the invention.

FIGS. 4A-4B are a flowchart of an operational sequence for processing network discovery data in accordance with an example of the invention.

FIG. 5 is a representation of a hierarchal order of data aggregations in accordance with an example of the invention.

### DETAILED DESCRIPTION

The nature, objectives, and advantages of the invention will become more apparent to those skilled in the art after considering the following detailed description in connection with the accompanying drawings.

### I. Hardware Components and Interconnections

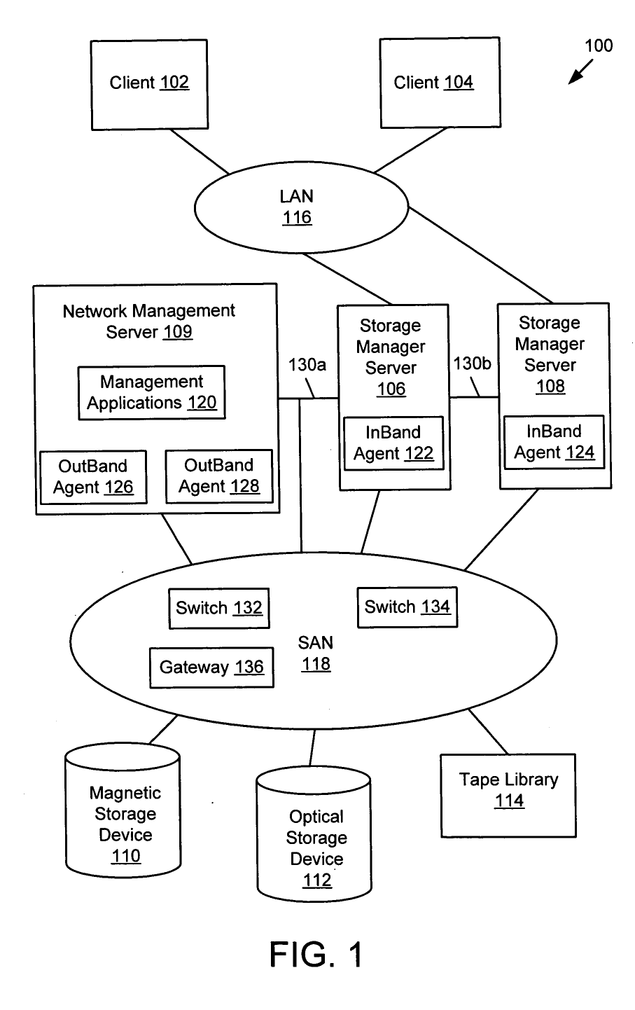

One aspect of the invention is a computing system for processing network discovery data. As an example, the computing system may be embodied by all, or portions of, the computing system 100 shown in FIG. 1. The computing system 100 may include one or more clients 102, 104, one or more storage manager servers 106, 108 (also called managed hosts), one or more network management servers 109 (also called a management client), a plurality of storage devices 110, 112, 114, a LAN 116, and a SAN 118.

The storage manager servers 106, 108 may communicate with the clients 102, 104 via the LAN 116, or alternatively via a WAN. Data associated with the clients 102, 104 may reside on the storage devices 110, 112, 114 that are coupled to the SAN 118. As an example, the storage devices 110, 112, 114 may include one or more magnetic storage devices 110 (such as magnetic disk drives), optical storage devices 112 (such as optical storage drives), and/or tape libraries 114, and any other suitable types of storage devices. Generally, a large number of storage devices may be coupled to the SAN 118. The SAN 118 may also include connection components such as switches 132, 134, gateway 136, and directors, hubs, links, etc. As an example switches 132, 134 may be IBM® model 2109 switches.

The SAN 118 may be implemented with Fibre Channel, iSCSI, or any other suitable network technology or protocol. There are a variety of computer hardware and software components that may be used to implement the various elements that make up the SAN 118. Commonly, a Fibre Channel architecture implemented using copper or fiber optical media will be used to provide the physical and low level protocol layers. Higher level protocols, such SCSI-FCP (Small Computer System Interface-Fibre Channel Protocol), IPI (Intelligent Peripheral Interface), IP (Internet Protocol), FICON (Fiber Optic CONnection), etc., may be mapped onto the Fibre Channel protocol stack. The Fibre Channel architecture generally will dictate the choice of devices that may be used to implement the interconnection components of the SAN 118, as well as the network interface adaptors and controllers that connect the storage manager servers 106, 108, the network management server 109, and storage devices 110, 112, 114 to the SAN 118. In alternative embodiments, a low level network protocol, such as Ethernet, could be used to implement the SAN 118. In some alternative embodiments, a network other than a SAN could be utilized in place of the SAN 118.

The storage manager servers 106, 108 may be configured as SAN application servers offering SAN access interfaces to the clients 102, 104. As an example, the storage manager servers 106, 108 and/or the network management server 109 could be implemented with IBM® zSeries®, iSeries™, pSeries™ or xSeries® system products, each of which provides a hardware and operating system platform set. Each storage manager server 106, 108 may be programmed with higher level SAN server application software, such as the IBM® TIVOLI® Storage Manager system. Generally, the clients 102, 104, the storage manager servers 106, 108, and/or the network management server 109 could each be implemented, for example, with a computer running the AIX operating system, a Windows 2000 server, or generally any Intel based PC server system. In one specific example, the network management server 109 could be implemented with an IBM® xSeries model 330.

The storage devices 110, 112, 114 may be implemented using any of a variety of data storage device products. As an example the storage devices 110, 112, 114 could include an IBM® TotalStorage ENTERPRISE STORAGE SERVER® (ESS) System, an IBM® FAStT 900 disk storage system, an IBM® proSCSI JBOD system, and/or an IBM® TotalStorage Enterprise Tape System. Generally, any suitable storage devices could be coupled to the SAN 118, and any suitable computing devices could be used to implement the clients 102, 104, the storage manager servers 106, 108, and the network management server 109.

The SAN 118 interconnection components may include switches 132, 134, and gateway 136, and any number of directors, hubs, bridges, routers, additional switches and gateways, etc., which are generally widely available from a variety of vendors. As an example, the links interconnecting these components may be constructed using copper wiring or single-mode or multi-mode optical fiber.

As mentioned above, data storage area networks typically employ standardized discovery entities, referred to as “agents,” (which may be called discovery agents or discovery agent services), that assist high level management applications 120 (also called network managers), obtain data storage network information. The management applications 120 may run on the network management server 109 (also called the management client 109). An agent may generally be thought of as an information gathering entity within a computing network, which has the ability to gather network information within a sphere of discovery capability. An inband agent 122 may be installed on storage manager server 106, and similarly, an inband agent 124 may be installed on storage manager server 108. Outband agents 126, 128 may run on the network management server 109. Additional agents may also be installed on storage devices 110, 112, 114, or on other devices, attached to the SAN 118. As an example, the network management applications 120 and the outband agents 126, 128 that operate on the network management server 109 may be implemented using any of a variety of conventional network management software products, for example the IBM® TIVOLI® Storage Area Network Manager. One or both of the storage manager servers 106, 108 may be managed hosts which are managed by the management applications 120 on the network management server 109.

The management applications 120 may communicate with the inband agents 122, 124 via a via a communication network, such as the IP network that has IP network segments 130a and 130b, which may be separate from the communication pathways of the data storage network being managed (for example SAN 118). The outband agents 126, 128 may conduct discovery by issuing queries to the switches 132, 134 in the SAN 118, via the IP network segment 130a. In contrast, the inband agents 122, 124 may conduct discovery by issuing queries via the communication pathways (network links) of the SAN 118.

As an example, a Fibre Channel switch, may have sixteen Fibre Channel ports, and one Ethernet port (a management port), which may be coupled to a WAN or LAN, and which may be used for querying the switch. Inband agents 122, 124 must use the Fibre Channel ports for querying the switch.

A variety of inband and outband discovery protocols have been developed for obtaining information about data storage network topology and component attributes. With respect to inband component attribute discovery, devices that may have SCSI interfaces, such as the storage devices 110, 112, 114, and the gateway 136, may be polled by the inband agents 122, 124 using SCSI queries to obtain device attribute information, including physical and logical storage unit identification information, port information, and the like. The inband agents 122, 124 may also perform self-discovery to obtain attribute information about the storage manager servers 106, 108, such as file system information and operating system information. As an example, inband topology queries may be performed by the inband agents 122, 124 using the Fibre Channel GS-3 (Generic Services) protocol (FC-GS-3) and the Fibre Channel FS (Framing and Signaling) protocol (FC-FS), to query the switches 132, 136 and to obtain fabric configuration and end node information. In addition to being responsive to queries from the inband agents 122, 124, all devices implementing SCSI interfaces, HBA (Hardware Bus Adapter) drivers, and the FC-GS-3 protocol, will generally support the reporting of device and fabric events as they occur in the data storage network. With regard to outband discovery, a widely used protocol is SNMP (Simple Network Management Protocol).

The outband agents 126, 128 may be configured to use management ports to issue SNMP queries to the switches 132, 134, as well as to receive port topology information and fabric events as they occur in the SAN 118. To that end, the switches 132, 134 may implement SNMP agents (not shown) that interact with the outband agents 126, 128. The Network Management Server 109 may include a database (not shown) for storing discovery information. The management applications 120 and outband agents 126, 128 and associated hardware on the network management server 109 may be called a manager appliance.

The inband agents 122, 124 may include sets of scanners (not shown) that are programmed to obtain attribute and topology information using different discovery protocols, such as the SCSI protocol, the FC-GS-3 protocol, and the FC-FS protocol. Additional scanners, such as ED/FI (Error Detection/Fault Isolation) statistics collection scanners, and CIM (Common Information Model) subsystem scanners, may also be included. The outband agents 126, 128 may include conventional SNMP support logic, which may include logic for gathering information described by a MIB (Management Information Base), logic for responding to queries, and logic for reporting network events (traps) to the management component. The SNMP support logic may be used to implement one or more outband scanners, such as a topology scanner and an ED/FI scanner. Additional scanners could also be provided for implementing proprietary APIs, such as the BROCADE® API (Application Programming Interface) for querying BROCADE® switches.

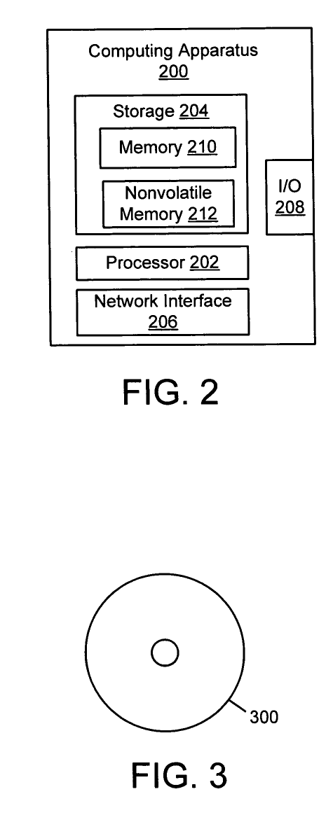

An exemplary computing apparatus 200 is shown in FIG. 2. As an example, the clients 102, 104, the storage manager servers 106, 108, the network management server 109, and any other computing devices in the computing system 100 could be implemented with an example of the computing apparatus 200. The computing apparatus 200 includes a processor 202 (which may be called a processing device), and in some examples could have more than one processor 202. As an example, the processor may be a PowerPC RISC processor, available from International Business Machines Corporation, or a processor manufactured by Intel Corporation. The processor 202 may run any suitable operating system, for example, Windows 2000, AIX, Solaris™, Linux, UNIX, or HP-UX™. The computing apparatus 200 may be implemented on any suitable computing device, for example a personal computer, a workstation, a mainframe computer, or a supercomputer. The computing apparatus 200 also includes a storage 204, a network interface 206, and an input/output 208, which are all coupled to the processor 202. The storage 204 may include a primary memory 210, which for example, may be RAM, and a non volatile memory 212. The non-volatile memory 212 could be, for example, a hard disk drive, a drive for reading and writing from optical or magneto-optical media, a tape drive, non-volatile RAM (NVRAM), or any other suitable type of storage. The storage 204 may be used to store data and application programs and/or other programming instructions executed by the processor. The application programs could generally be any suitable applications. The network interface 206 may provide access to any suitable wired or wireless network.

### II. Operation

In addition to the hardware embodiments described above, other aspects of the invention concern a method for processing network discovery data.

### A. Signal-Bearing Media

In the context of FIGS. 1 and 2, the method aspects of the invention may be implemented, for example, by having the network management server 109, and/or the storage manager servers 106, 108, and in some examples, also one or more of the agents, execute a sequence of machine-readable instructions, which can also be referred to as code. These instructions may reside in various types of signal-bearing media. In this respect, some aspects of the present invention concern a programmed product, comprising a signal-bearing medium or signal-bearing media tangibly embodying a program of machine-readable instructions executable by a digital processing apparatus to perform operations for processing network discovery data.

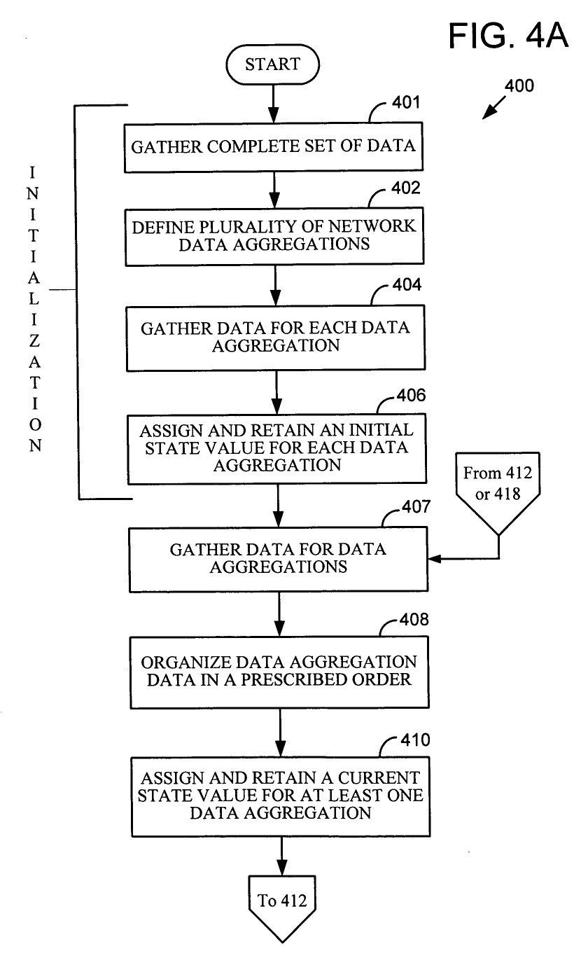

This signal-bearing medium may comprise, for example, primary memory 210 and/or non-volatile memory 212. Alternatively, the instructions may be embodied in a signal-bearing medium such as the optical data storage disc 300 shown in FIG. 3. The optical disc can be any type of signal bearing disc or disk, for example, a CD-ROM, CD-R, CD-RW, WORM, DVD−R, DVD+R, DVD-RW, or DVD+RW. Additionally, whether contained in the computing system 100, or elsewhere, the instructions may be stored on any of a variety of machine-readable data storage mediums or media, which may include, for example, a “hard drive”, a RAID array, a magnetic data storage diskette (such as a floppy disk), magnetic tape, digital optical tape, RAM, ROM, EPROM, EEPROM, flash memory, programmable logic, any other type of firmware, magneto-optical storage, paper punch cards, or any other suitable signal-bearing media including transmission media such as digital and/or analog communications links, which may be electrical, optical, and/or wireless. For example, in some embodiments the instructions or code may be accessible from a file server over a network, or from other transmission media, and the signal bearing media embodying the instructions or code may comprise a transmission media, such as a network transmission line, wireless transmission media, signals propagating through space, radio waves, and/or infrared signals. Additionally, the signal bearing media may be implemented in hardware logic, for example, an integrated circuit chip, a Programmable Gate Array (PGA), an Application Specific Integrated Circuit (ASIC). As an example, the machine-readable instructions may comprise software object code, compiled from a language such as “C++”.

### B. Overall Sequence of Operation

Techniques for discovering network information from discovery agents are described in U.S. patent application Ser. No. 10/666,046, filed Sep. 20, 2003, titled “Intelligent Discovery of Network Information from Multiple Information Gathering Agents” which is incorporated herein by reference.

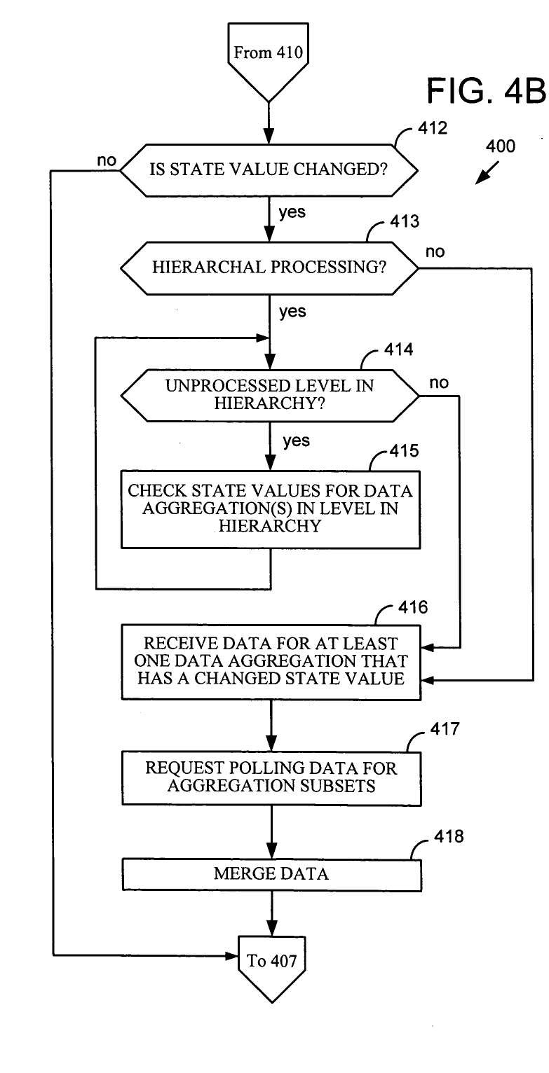

For ease of explanation, but without any intended limitation, exemplary method aspects of the invention are described with reference to the computing system 100 described above and shown in FIG. 1. An example of the method aspect of the present invention is illustrated in FIGS. 4A-B, which show a sequence 400 for a method for processing network discovery data.

The operations of the sequence 400 may be performed the network management server 109, or by the network management server 109 in conjunction with one or more discovery agents, which may be located on one or more of the storage manager servers 106, 108, or elsewhere in the computing system 100. Alternatively, the operations of the sequence could be performed by one or more of the storage manager servers 106, 108, or by the network management server 109 and one or more of the storage manager servers 106, 108, and in some embodiments may also be performed in conjunction with other agents and components in the computing system 100. Agents outside of the network management server 109 are not required for practicing some examples of the invention, because some examples of the invention could run completely on the management server 109.

Prior to operation of the sequence 400, typically, the system boundaries will be known, the agents and the capabilities of the agents will be known, and the desired discovery services will be identified. Sequence 400 may include, and may begin with, operation 401, which comprises initially gathering a complete set of data. The complete set of data may be gathered by the set of designated SAN discovery agents for the system. The data may include, for example, zoning information, topology information, and/or device attributes information, etc. Data collection by the agent services may involve either polling devices or receiving notifications from devices that give information about the SAN.

The sequence 400 may also include operation 402, which comprises defining a plurality of network data aggregations (also called sections), which may also be characterized as defining data aggregation boundaries or as compiling, organizing, or dividing data into aggregations. Data aggregations generally are chosen so that data aggregations may be easily removed and merged when generating a view of a network. As an example, the plurality of network data aggregations may be defined based on zoning information including zone and zone set (which are logical entities). A zone may be defined as a set of N ports in a fabric that make up a logical boundary. Defining data aggregations by zone provides granularity. In another example, the plurality of network data aggregations may be defined based on topology information, for example SAN and domain address (for example by using domain IDs associated with switches). Using topology information may be particularly useful for large SANs. In another example, the plurality of network data aggregations may be defined based on device attributes information, for example device and port, where similar types of devices, or product models could be grouped together. In other examples the data aggregations could be based on fabric. A fabric may be defined as a coherent interconnection of switch links having a common address space and a common protocol. Different fabrics may be separated by a bridge or a router. For example, a Fibre Channel fabric and an iSCSI fabric could be separated with a gateway. In other examples, data aggregations could be based on switch boundaries. If switch boundaries are used, switches with high adjacency (switches that have the most interswitch links between them) may be grouped, and the boundaries may be defined at links chosen to minimize the number of links at the boundaries. If switch boundaries are used, interswitch links may be used to identify data aggregations. Using switch boundaries provides granularity. Switch sets may be identified by World Wide names. In other examples the data aggregations could be based on virtualization layers, or could be based on SAN boundaries. In some examples a management client 109 could send a request that specifies aggregation policy, and may be able to optimize the boundaries. Generally, agent services collect the data and in some examples may organize the data. In some alternative embodiments, defining data aggregations permits providing event notifications, or notification of changes, that occur in one or more data aggregations.

The following is an example of data aggregation boundaries, in an XML file using DTD format, prior to the assignment of state values. More specifically, the following is an example of a DTD (from the IBM® Tivoli® SAN Manager agent design), which aggregates by SAN element type using an XML type format. (An example of a DTD output file with the data aggregations included, is discussed further below.) In order to find a description of some type of device in the SAN desired to be seen, the appropriate code word may be searched for in the DTD. Fox example, to find a particular zone set, the term “ZoneSetIdXml” could be searched. SanXml shows what switches are in the SAN, and ID is the World Wide Name of a primary switch. InterconnectElementXml displays the ports connected to each switch. ZoneXml displays what is in each zone. This first exemplary DTD output file is as follows:

<?xml version=”1.0?>
<!DOCTYPE TopologyXml }> >
<!ELEMENT ZoneMemberXml (UniqueIdXml, ParameterXml*)>
<!ELEMENT PlatformXml (UniqueIdXml, ParameterXml*,
FcNodeIdXml*)>
<!ELEMENT SystemXml (UniqueIdXml, ParameterXml*,
ControllerIdXml*)>
<!ELEMENT ControllerXml (UniqueIdXml, ParameterXml*,
FcNodeIdXml*)>
<!ELEMENT FcPortXml (UniqueIdXml, ParameterXml*,
AttachedFcPortIdXml*)>
<!ELEMENT FcNodeXml (UniqueIdXml, ParameterXml*,
FcPortIdXml*)>
<!ELEMENT ParameterXml (NameXml, ValueXml)>
<!ELEMENT UniqueIdXml (#PCDATA)>
<!ELEMENT FcPortXml (#PCDATA)>
<!ELEMENT InterconnectElementIdXml (#PCDATA)>
<!ELEMENT ZoneSetIdXml (#PCDATA)>
<!ELEMENT ZoneIdXml (#PCDATA)>
<!ELEMENT FcNodeIdXml (#PCDATA)>
<!ELEMENT AttachedFcPortIdXml (#PCDATA)>
<!ELEMENT ControllerIdXml (#PCDATA)>
<!ELEMENT NameXml (#PCDATA)>
<!ELEMENT ValueXml (#PCDATA)>}><!--End Topology.dtd-->]>

The sequence 400 may further include operation 404, which comprises gathering data (collecting data) for each data aggregation prior to performing operation 406 (described below). The data may be gathered by polling agents, or by receiving notifications from agents to gather data.

The sequence 400 may further include operation 406, which comprises assigning an initial state value for each data aggregation. Operation 406 may also include retaining the initial state values, and may further include retaining the corresponding data. The operation 406 of assigning an initial state value for each data aggregation may also include organizing the data in the data aggregations in a prescribed order (as discussed below with regard to operation 408). All of the information registered for by the management client 109, including the initial state data, may be transmitted from agent discovery services to the management client 109, so the management client 109 may construct an initial view (also called a graph) of the network. Alternatively, the management client 109 may assign the initial state values. State values are discussed further below with regard to operation 410. In some examples, CIM data could be packaged and sent via a distributed communication service such as http.

Operations 401-406, described above, comprise an initialization phase of sequence 400 which need not be repeated. After operation 406 has been performed, initialization is complete, and the monitoring phase, described in operations 407-418 below, may commence. One or more of the operations of the monitoring phase may be repeated as many times as desired. The advantages provided by some embodiments of the invention are most evident in the monitoring phase.

Operation 407 comprises gathering data for each data aggregation to which a current state value is to be assigned, prior to performing operations 408 and 410 (described below). Data need not be gathered for each data aggregation. For example, data could be gathered only near a change. In a specific example, data could be gathered in a data aggregation defined by a fabric boundary (which, for example, could comprise four switches.) As in operation 404, the data may be gathered by polling agents, or by receiving notifications from agents to gather data.

The sequence 400 may further include operation 408, which comprises, prior to the operation 410 of assigning a current state value to at least one of the data aggregations, organizing data in the at least one of the data aggregations in a prescribed order. Because the data is organized into a prescribed order, when the data is traversed to determine the current state value of the data aggregation, the data is traversed in a particular order. The data could be placed in a canonical or normalized form, for example, by using any of the following techniques: performing a simple sort (for example by Fibre Channel World Wide Name), hashing, using B+, using a binary tree, or by using a physical or logical graph. In an alternative embodiment the data could be sorted into table rows and columns (for example for use with SQL). In another alternative embodiment XML could be used to organize data and network views. Rather than placing the data in a prescribed order, in another alternative embodiment, the operation 410 (discussed below) of assigning a current state value to at least one of the data aggregations may comprise processing data in the at least one of the data aggregations in a prescribed order.

The sequence 400 may further include operation 410, which comprises assigning a current state value to at least one of the data aggregations. Operation 410 may also include retaining the current state values, and may further include retaining the corresponding data. The operation of assigning a current state value to at least one of the data aggregations may be performed by at least one agent discovery service, or alternatively, may be performed by a management client 109. As an example, each current state value may be a CRC (Cyclical Redundancy Code) value computed utilizing data associated with a corresponding data aggregation and a CRC polynomial. For example, a 32 bit CRC polynomial employed in Fibre Channel protocol could be utilized, wherein the polynomial has the following form: x³²+x²⁶+x²³+x²²+x¹⁶+x¹²+x¹¹+x¹⁰+x⁸+x⁷+x⁵+x⁴+x²+x+1. In another example with a current state value may be a checksum computed against data associated with a corresponding data aggregation. Any method for state assignment that describes the state of the aggregation could be used. The first DTD example above does not provide a place in the format for a state variable. The following DTD is modified to show a place for a state element for each aggregation type. The XML file is broken down by management data field type in the DTD file, which shows a summary of the XML file. This second exemplary DTD output file is as follows:

<?xml version=”1.0?>
<!DOCTYPE TopologyXml [<!-- Topology.dtd -->
<!ELEMENT TopologyXml (HeaderXml, SanXml*, InterconnectElementXml*,
ZoneXml*, PlatformXml*, SystemXml*, ControllerXml*, FcPortXml*, FcNodeXml*,
ZoneSetXml*, ZoneMemberXml*)>
<!ELEMENT HeaderXml (ParameterXml*)>
<!ELEMENT SanXml (UniqueIdXml, ParameterXml*, InterconnectElementIdXml*,
FcPortIdXml*, ZoneSetIdXml*)>
<!ELEMENT SanAggregationStateXml(UniqueIdXml)>
<!ELEMENT InterconnectElementXml (UniqueIdXml, ParameterXml*,
FcPortIdXml*)>
<!ELEMENT InterconnectelementAggregationStateXml (UniqueIdXml)>
<!ELEMENT ZoneSetXml (UniqueIdXml, ParameterXml*, ZoneIdXml*)>
<!ELEMENT ZoneSetAggregationStateXml (UniqueIdXml)>
<!ELEMENT ZoneXml (UniqueIdXml, ParameterXml*, FcPortIdXml*)>
<!ELEMENT ZoneAggregationStateXml (UniqueIdXml)>
<!ELEMENT ZoneMemberXml (UniqueIdXml, ParameterXml*)>
<!ELEMENT ZoneMemberAggregationStateXml (UniqueIdXml)>
<!ELEMENT PlatformXml (UniqueIdXml, ParameterXml*, FcNodeIdXml*)>
<!ELEMENT PlatformAggregationStateXml (UniqueIdXml)>
<!ELEMENT SystemXml (UniqueIdXml, ParameterXml*, ControllerIdXml*)>
<!ELEMENT SystemAggregationStateXml (UniqueIdXml)>
<!ELEMENT ControllerXml (UniqueIdXml, ParameterXml*, FcNodeIdXml*)>
<!ELEMENT ControllerAggregationStateXml (UniqueIdXml)>
<!ELEMENT FcPortXml (UniqueIdXml, ParameterXml*, AttachedFcPortIdXml*)>
<!ELEMENT FcPortAggregationStateXml (UniqueIdXml)>
<!ELEMENT FcNodeXml (UniqueIdXml, ParameterXml*, FcPortIdXml*)>
<!ELEMENT FcNodeAggregationStateXml (UniqueIdXml)>
<!ELEMENT ParameterXml (NameXml, ValueXml)>
<!ELEMENT UniqueIdXml (#PCDATA)>
<!ELEMENT FcPortXml (#PCDATA)>
<!ELEMENT InterconnectElementIdXml (#PCDATA)>
<!ELEMENT ZoneSetIdXml (#PCDATA)>
<!ELEMENT ZoneIdXml (#PCDATA)>
<!ELEMENT FcNodeIdXml (#PCDATA)>
<!ELEMENT AttachedFcPortIdXml (#PCDATA)>
<!ELEMENT ControllerIdXml (#PCDATA)>
<!ELEMENT NameXml (#PCDATA)>
<!ELEMENT ValueXml (#PCDATA)>}><!--End Topology.dtd-->]>

Referring to FIG. 4B, the sequence 400 may further include operation 412, which comprises, for at least one (and in some examples, for each) current state value, determining if the current state value is different than a corresponding prior state value, due to a change in the data. As an example, the corresponding prior state value may be the most recent state value before the current state value for a data aggregation. Changes in the network cause the data to change. The following are some examples of changes that may take place in a network: switches, gateways, routers, storage devices, or other components may be added or removed, or links may be degraded or improved.

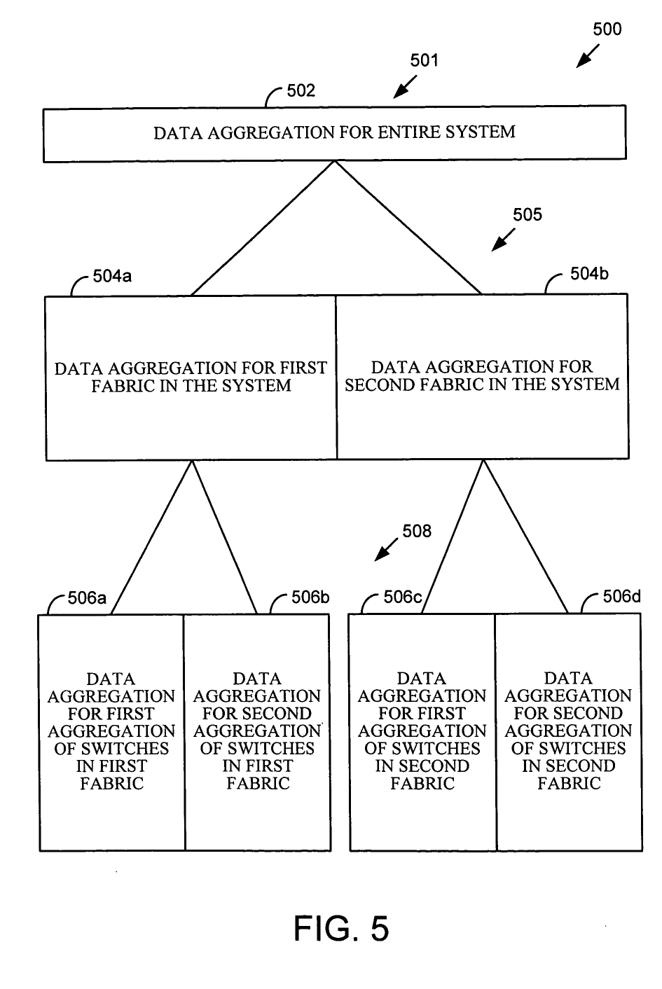

If desired, the comparison of current and prior state values may be conducted for data aggregations in a hierarchal fashion, for example using the hierarchy 500 shown in FIG. 5. In this case the analysis may begin with larger data aggregations, and may be continued down to smaller data aggregations in a hierarchal order, wherein the smaller data aggregations (which could be as small as a single switch) may be subsets of larger data aggregations (which could be as large as an entire network). With this technique, instead of initially conducting time consuming low level comparisons, the management server 109 may start at a top level with a large data aggregation, which may be considered to be a compilation of subset data aggregations, and then may analyze subsets only if there is a state change in the superset. Thus, some examples of the invention provide for hierarchal analysis at various granularities, and may be scaled to large environments. Conducting the analysis in a hierarchal order permits speeding up the processing by eliminating data aggregations from further analysis if they have no changes. For example, operations 407 to 412 may first be conducted at a top level 501 of the hierarchy 500 for a data aggregation 502 that includes an entire system. If in operation 412 it is determined that the current state value for the data aggregation 502 that includes the entire system is the same as a corresponding prior state value, then the analysis may be efficiently ended at this point (and, if desired, the sequence 400 beginning at operation 407 may subsequently be repeated for the data aggregation 502 that includes the entire system). Thus, the analysis may advantageously be quickly completed when it is determined that the current state value is the same as a corresponding prior state value. This procedure is particularly useful in examples where a network management client 109 periodically polls agents to receive data.

If the current state value for the data aggregation 502 that includes the entire system is different than the corresponding prior state variable, then operation 413 (shown in FIG. 4B) may be performed, which comprises determining if a hierarchal analysis is to be conducted. If it is determined that a hierarchal analysis is not to be conducted, then one or more of operations 416, 417, and 418 may be performed, as discussed below. If in operation 413 it is determined that hierarchal analysis is to be conducted, then operation 414 (shown in FIG. 4B) may be performed, which comprises determining whether there is a lower level in the hierarchy that has not been processed. If in operation 414 it is determined that there is a level in the hierarchy that has not been processed (for which current and prior state values have not been compared), then operation 415 may be performed, which comprises checking state values for one or more data aggregations in the next level of the hierarchy that has not been processed. For example, a current state value may be compared to a prior state value for data aggregation 504a, and a current state value may be compared to a prior state value for data aggregation 504b, for the middle level 505 of the hierarchy 500 (shown in FIG. 5). Performing this analysis at the middle level 505 of the hierarchy 500 permits identifying the location of a change in the network with more accuracy, by identifying whether a change has occurred in the data aggregation 504a corresponding with the first fabric, or in the data aggregation 504b corresponding with the second fabric. (Although possible, it is unlikely that changes will occur in both fabrics in the time during the analysis.) After a fabric is identified in which the current state value is different than a corresponding prior state value, then operation 414, which comprises determining whether there is a lower level in the hierarchy that has not been processed, may be performed again. If in operation 414 it is determined that there is a level in the hierarchy that has not been processed, then operation 415 may be performed again. For example, if it was previously determined that a change occurred in the first fabric, then in operation 415, a current state value may be compared to a prior state value for data aggregation 506a, and a current state value may be compared to a prior state value for data aggregation 506b, in the bottom level 508 of the hierarchy 500 (shown in FIG. 5). On the other hand, if it was previously determined that a change occurred in the second fabric, then operation 415 may be performed with state values for data aggregations 506c and 506d. Performing operation 415 with state values corresponding with data aggregations at the bottom level 508 of the hierarchy 500 permits defining an aggregation of switches in which the change has occurred, without having to perform the analysis on all of the aggregations of switches in the bottom level 508 of the hierarchy 500. After an aggregation of switches is identified in which the current state value is different than a corresponding prior state value, then operation 414, which comprises determining whether there is a lower level in the hierarchy that has not been processed, may be performed again. If there is no lower level in the hierarchy that has not been processed, then one or more of operations 416, 417, and 418 may be performed, as discussed below, starting with performing operation 416 for the aggregation of switches for which the current state value is different than a prior state value.

Referring again to FIG. 4B, if in operation 413 it is determined that hierarchal processing is not to take place, or if in operation 414 it is determined that there are no levels in the hierarchy that have not been processed, then the sequence 400 may further include one or more of operations 416, 417, and 418. Operation 416 comprises receiving data corresponding with at least one (and in some examples, corresponding with each) data aggregation that has a current state value that is different than a corresponding prior state value, for example, as identified in operation 412, or, if hierarchal processing is performed, as identified in the most recent prior performance of operation 415. Thus, data corresponding with data aggregations that have changes may be sent to the management client 109, and data corresponding with unchanged data aggregations does not have to be sent to the management client 109. In some examples, data corresponding with at least one (and in some examples, corresponding with each) data aggregation that has a current state value that is not different than a corresponding prior state value could also be received by the management client 109. The data may be received by the management client 109 from agent discovery services. The management client 109 could request the data, or the data could automatically be transmitted from discovery agents. As an example, if a zone obtains an additional entry, with reference to the exemplary DTD files above, the data that would be sent to the management client 109 would only be the ZoneMemberXml. In an alternative example, all data could be sent to the management client 109. A release mechanism may be included, for discovery agents to erase the data transmitted to the management client 109 the after the management client 109 has received the data.

Operation 417 comprises requesting polling on data aggregations that are subsets of a corresponding superset data aggregation that have a current state value that is different than a corresponding prior state value. The management client 109 may request the polling. Polling may be requested because not all aspects of a SAN are equally important or interesting to a management service. This capability provides an agent service that allows registration not on just a type of event, but on a defined aggregation. This permits greater flexibility in management functions, and eliminates data reporting and analysis that is uninteresting to the manager.

Operation 418 comprises merging at least some data corresponding with at least one (and in some examples, corresponding with each) data aggregation determined to have a current state value that is different than a corresponding prior state value, with prior data corresponding with at least one data aggregation determined to have a current state value that is not different than a corresponding prior state value. If the boundaries are well chosen, new data in data aggregations where there is no change can be ignored. In data aggregations where the state has changed, the old data may be discarded and replaced with new data. The new data for the changed data aggregations is appended to old data for data aggregations that have not changed. Thus, the management client 109 merges the data to reconcile a new system representation of the management data. For example, in the case of the second exemplary DTD output file discussed above wherein the data is stored in an XML file, the file format provides clear data aggregation boundaries that can be easily managed. For example, the XML starting and ending tags associated with a data aggregation, and standard file manipulation methods, can be used to identify, remove, and replace data in a changed data aggregation with data that represents the current state of the system.

After operation 412 or operation 418, the monitoring phase of sequence 400 may be repeated, beginning with operation 407. Thus, one or more of operations 407 to 418 maybe repeated.

Some examples of the invention may be described as intelligent discovery agent services for minimizing client analysis. Some examples may be implemented as a method and computing system for performing intelligent discovery of a SAN by organizing the data reported by SAN discovery agents into states corresponding with data aggregations, and using the state information to minimize transmissions between agent services and a management client 109 requesting discovery services. In accordance with some examples of the invention, one or more SAN management clients 109 compare current state information with prior state information, without having to perform analysis steps where state data has not changed, thereby leveraging SAN discovery agent aggregation and minimizing analysis time.

### III. Other Embodiments

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

1. A signal bearing medium tangibly embodying a program of machine-readable instructions executable by a digital processing apparatus to perform operations for processing network discovery data, the operations comprising:
defining a plurality of network data aggregations;
assigning a current state value to at least one of the data aggregations;
for at least one current state value, determining if the current state value is different than a corresponding prior state value; and
merging data corresponding with at least one data aggregation determined to have a current state value that is different than a corresponding prior state value, with prior data corresponding with at least one data aggregation determined to have a current state value that is not different than a corresponding prior state value.

2. The signal bearing medium of claim 1, wherein the plurality of network data aggregations are defined based on zoning information.

3. The signal bearing medium of claim 1, wherein the plurality of network data aggregations are defined based on topology information.

4. The signal bearing medium of claim 1, wherein the plurality of network data aggregations are defined based on device attributes information.

5. The signal bearing medium of claim 1, wherein the operations further comprise polling agents, to gather data for the at least one data aggregation to which a current state value is to be assigned.

6. The signal bearing medium of claim 1, wherein the operations further comprise receiving notifications from agents, to gather data for the at least one data aggregation to which a current state value is to be assigned.

7. The signal bearing medium of claim 1, wherein the operations further comprise assigning an initial state value for each data aggregation.

8. The signal bearing medium of claim 1, wherein the operation of assigning a current state value to at least one of the data aggregations is performed by at least one agent discovery service.

9. The signal bearing medium of claim 1, wherein the operation of assigning a current state value to at least one of the data aggregations is performed by a management client.

10. The signal bearing medium of claim 1, wherein the operation of assigning a current state value to at least one of the data aggregations comprises processing data in the at least one of the data aggregations in a prescribed order.

11. The signal bearing medium of claim 1, wherein the operations further comprise, prior to the operation of assigning a current state value to at least one of the data aggregations, organizing data in the at least one of the data aggregations in a prescribed order.

12. The signal bearing medium of claim 1, wherein each current state value is a CRC value computed using data associated with a corresponding data aggregation, and a CRC polynomial.

13. The signal bearing medium of claim 1, wherein each current state value is a checksum computed against data associated with a corresponding data aggregation.

14. The signal bearing medium of claim 1, wherein the operations further comprise receiving data corresponding with at least one data aggregation wherein the current state value is different than a corresponding prior state value.

15. The signal bearing medium of claim 1, wherein the operations further comprise receiving data corresponding with at least one data aggregation wherein the current state value is not different than a corresponding prior state value.

16. The signal bearing medium of claim 1, wherein the operation of, for at least one current state value, determining if the current state value is different than a corresponding prior state value, is performed for each of a plurality of levels in a hierarchy of data aggregations.

17. The signal bearing medium of claim 16, wherein the plurality of data aggregations includes at least one data aggregation that is a subset of a corresponding superset data aggregation, and wherein the subset data aggregation is located in the hierarchal ordering after the corresponding superset data aggregation.

18. The signal bearing medium of claim 1, wherein the operations further comprise requesting polling on data aggregations that are subsets of a superset data aggregation that has a changed state value.

19. A computing system, comprising:
a memory; and
a processing device coupled to the memory, wherein the processing device is programmed to perform operations for processing network discovery data, the operations comprising:
defining a plurality of network data aggregations;
assigning a current state value to at least one of the data aggregations;
for at least one current state value, determining if the current state value is different than a corresponding prior state value; and
merging data corresponding with at least one data aggregation determined to have a current state value that is different than a corresponding prior state value, with prior data corresponding with at least one data aggregation determined to have a current state value that is not different than a corresponding prior state value.

20. The computing system of claim 19, further comprising at least one discovery agent coupled to the processing device.

21. The computing system of claim 19, wherein the operation of, for at least one current state value, determining if the current state value is different than a corresponding prior state value, is performed for each of a plurality of levels in a hierarchy of data aggregations.

22. The computing system of claim 19, wherein the operations further comprise, prior to the operation of assigning a current state value to at least one of the data aggregations, organizing data in the at least one of the data aggregations in a prescribed order.

23. A computing system, comprising:
means for defining a plurality of network data aggregations;
means for assigning a current state value to at least one of the data aggregations;
for at least one current state value, means for determining if the current state value is different than a corresponding prior state value; and
means for merging data corresponding with at least one data aggregation determined to have a current state value that is different than a corresponding prior state value, with prior data corresponding with at least one data aggregation determined to have a current state value that is not different than a corresponding prior state value.

24. A method for obtaining network discovery data, the operations comprising:
defining a plurality of network data aggregations;
assigning a current state value to at least one of the data aggregations;
for at least one current state value, determining if the current state value is different than a corresponding prior state value; and
merging data corresponding with at least one data aggregation determined to have a current state value that is different than a corresponding prior state value, with prior data corresponding with at least one data aggregation determined to have a current state value that is not different than a corresponding prior state value.

25. The method of claim 24, wherein the operations further comprise, prior to the operation of assigning a current state value to at least one of the data aggregations, organizing data in the at least one of the data aggregations in a prescribed order.

26. The method of claim 24, wherein the operation of, for at least one current state value, determining if the current state value is different than a corresponding prior state value, is performed for each of a plurality of levels in a hierarchy of data aggregations.
